(19) United States
(12) Patent Application Publication
(10) Pub. No.: US 2004/0075752 A1
(43) Pub. Date: Apr. 22, 2004

(54) Correlating asynchronously captured event data and images

(75) Inventors: Michael A. Valleriano, Webster, NY (US); Christopher I. Marshall, Pittsford, NY (US); Mark A. Bobb, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/273,871

(22) Filed: Oct. 18, 2002

(51) Int. Cl. H04N 5/76

(52) U.S. Cl. 348/231.3

(57) ABSTRACT

A method for correlating asynchronously captured event data and images associated with the events comprises the steps of: (a) capturing a plurality of images and recording data corresponding to the images, including a time of image capture for each image; (b) recording event data associated with a plurality of events, including a time of occurrence of each event, wherein a separator is produced between the event data corresponding to at least some of the events; and (c) correlating the images and the event data by relating an image that is associated in time with the separator to event data that is nearby the separator.

### FIELD OF THE INVENTION

The invention relates generally to the field of digital image processing, and in particular to the automatic correlation of images with objects in the images or events associated with the images.

### BACKGROUND OF THE INVENTION

There are a number of ways to identify a particular person within an image, picture or photo. One typical method provides the person with an identification number, and that identification number is then associated with an image. A few examples of such methods include magnetic stripe cards, bar codes, and radio frequency identification tags that are encoded with the person's identification number. The person's identification number is read before, during or after the image capture and the identification number is associated with the specific image by known methods (e.g., encoding the identification number in the image's metadata or recording the identification information in a database).

Eastman Kodak Co. has a number of products that associate a particular person with an image. For example, Kodak EPX Thrill Shots and Roving Photos, Kodak Image Magic Fantasy Theater and other Kodak products provide the subject with an identification (ID) tag that is associated with an image and used to find the image in an image database and produce a photographic product.

U.S. patent application Ser. No. US2002/0008622 A1, which was published Jan. 24, 2002, describes a method of associating a particular person with one or more images using a radio frequency identification (RFID) tag. The tags are worn by the park patrons during their visit to the park or other entertainment facility. Various readers distributed throughout the park or entertainment facility are able to read the RFID tags and reference unique identifier numbers. Thus, the unique identifier numbers can be conveniently read and provided to an associated photo/video capture system for purposes of providing indexing of captured images according to the unique identifiers of all individuals standing within the field of view of the camera. Captured photo images can thus be selectively retrieved and organized into a convenient photo/video album to provide a photo record of a family's or group's adventures at the park or other entertainment facility.

U.S. patent application Ser. No. US2002/0101519 A1, which was published Aug. 1, 2002, describes a system such as might be used on a cruise line that more generically associates a person having a tag (e.g. RFID) with a captured image. The system uses a transponder that generates and transmits a unique identification code uniquely identifying the subject of the photographic image to a remote detection unit located within a digital camera. Upon receipt, the unique identification code is verified to correspond with the intended subject of a photographic image, and upon successful verification, the image is recorded. The transmitted unique identification code is encoded in the associated recorded image data, and the data is transferred to a computer-readable storage medium and stored in a database. Once stored, the image can be securely accessed and displayed via a user interface using the associated unique identification code.

The prior art works well for images when one or just a few people are in an image and when the identities of the people can be synchronized with the capture of the images, that is, when the identifier codes and the images are systematically captured together (synchronously) and stored together. However, these systems are not able to handle large numbers of people in a single image and are difficult to apply to multiple images with the same people in each of them. Just as important, these systems are difficult to apply in a situation where the identifier codes are not specifically tied to a particular image, that is, the identifier codes and the images are obtained by systems that are not necessarily synchronized (i.e., asynchronous).

This problem is illustrated with the example of a foot race. At a race, the contestant initially registers by providing personal information that is stored in a registration database. The contestant is issued a Contestant ID number (CID) that is recorded in the registration database. The CID may also be provided on a bib, badge, pass or other article that the contestant can carry or wear. In the prior art, for example, the article could contain an RFID tag. These articles include the CID and may also include a unique tag article ID (TID) number. Information relating the CID and the TID is recorded in an article database (which could be different from the registration database).

Data gathering stations are located at one or more points around the race course. Each data gathering station includes a means to read information from the RFID tag (or other article) as the contestant passes the station, and a way to associate that information with other data such as time, location, lap, etc. This information is stored in a race time database. The data gathering station may also include at least one camera that captures one or more images as the contestant races past the station. Ordinarily, the camera associates data such as time of capture, image number, camera number, etc., with the image in an camera image database. The challenge is to correlate the information from the various databases using the CID, TID, time, location and other data. Similar situations occur at other events such as graduations, walks for charity, etc.

The charity event represents a simpler embodiment of the race scenario previously described. In this scenario, participants (instead of contestants) perform some activity such as walking, running, skating, bike riding or the like to help raise funds or attention for a charity. The start and finish line are frequently the same location, and there is usually only one data gathering location for the event, usually at the finish line.

A method is needed to easily associate all the people within a given photo with that particular image, and also to easily locate all images that include a particular person. Such a method is particularly needed in a system where the data about the event, including the identities of the participants, is asynchronously captured in relation to the images such that there is seldom a clear one-to-one relationship.

### SUMMARY OF THE INVENTION

The present invention is directed to overcoming one or more of the problems set forth above. Briefly summarized, according to one aspect of the present invention, a method for correlating asynchronously captured event data and images associated with the events comprises the steps of: (a) capturing a plurality of images and recording data corresponding to the images, including a time of image capture for each image; (b) recording event data associated with a plurality of events, including a time of occurrence of each event, wherein an separator is produced between the event data corresponding to at least some of the events; and (c) correlating the images and the event data by relating an image that is associated in time with the separator to event data that is nearby the separator.

The aforementioned separator is described herein without limitation to be a time gap or a location record that separates the event data. In one embodiment, the events include the placement of one or more persons in the captured images. The data associated with the plurality of events further includes identification of the persons placed in the images and the step (c) of correlating the images with the event data includes relating the captured images with the identification of the persons in the images.

The advantage of the invention lies in its ability to easily correlate asynchronously captured event data and images. As a result, in a charity event photo opportunity situation, it is possible to easily associate all the people within a given photo with that particular image, and also to easily locate all images that include a particular person.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a pictorial diagram of a computer system for implementing the present invention.

FIG. 2 is a block diagram of the basic functions performed according to the present invention.

FIG. 3 is a block diagram showing further detail of the preparation function shown in FIG. 2.

FIG. 4 is a pictorial illustration of a photographic area set up in the form of an enclosure (e.g., a tent) with several photographic stations for capturing the images of participants in an event.

FIG. 5 is a block diagram showing further detail of the capture function shown in FIG. 2.

FIG. 6 shows a database record configuration for storing tag and location data.

FIG. 7 shows a camera record configuration for storing capture time and date and other camera related identification data with image data.

FIG. 8 shows a typical workflow, at a given stage in the photographic area shown in FIG. 4, that provides time gaps that may be used to correlate the captured images with the identities of the participants in accordance with the invention.

### DETAILED DESCRIPTION OF THE INVENTION

Because image processing systems employing correlation and retrieval techniques are well known, the present description will be directed in particular to attributes forming part of, or cooperating more directly with, a method and system in accordance with the present invention. Method and system attributes not specifically shown or described herein may be selected from those known in the art. In the following description, a preferred embodiment of the present invention would ordinarily be implemented as a software program, although those skilled in the art will readily recognize that the equivalent of such software may also be constructed in hardware. Given the method and system as described according to the invention in the following materials, software not specifically shown, suggested or described herein that is useful for implementation of the invention is conventional and within the ordinary skill in such arts. If the invention is implemented as a computer program, the program may be stored in conventional computer readable storage medium, which may comprise, for example; magnetic storage media such as a magnetic disk (such as a floppy disk or a hard drive) or magnetic tape; optical storage media such as an optical disc, optical tape, or machine readable bar code; solid state electronic storage devices such as random access memory (RAM), or read only memory (ROM); or any other physical device or medium employed to store a computer program.

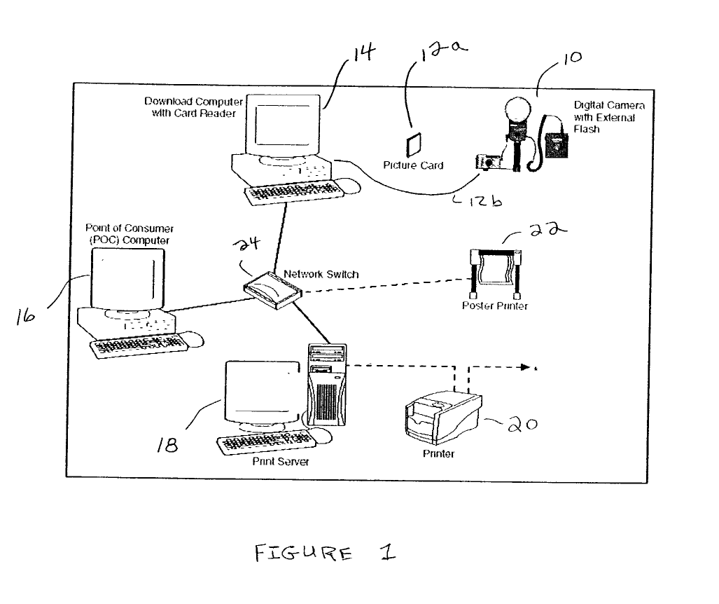

Referring to FIG. 1, there is illustrated a computer system for implementing the present invention. Although the computer system is shown for the purpose of illustrating a preferred embodiment, the present invention is not limited to the computer system shown, but may be used on any electronic processing system such as found in personal desktop or laptop computers or workstations, or any other system for the processing of digital images. The Kodak EPX system, a professional image operating system offered for the entertainment industry, serves as the basis for the photographic system used in this embodiment. This system includes one or more cameras 10 (which are preferably digital cameras capable of storing a considerable range of meta data (time, date, etc.) related to the captured images or Advanced Photo System (APS) cameras capable of recording a similar but usually lesser range of data on a magnetic region of its APS film). Images are captured by one or more of the cameras 10 and entered into the EPX system via removable storage media 12a (e.g., a Compact Flash card) or by a tethered link 12b between the camera 10 and a download computer 14. A point of consumer (POC) computer 16 is used to find, preview, edit and select images for output. Images selected for output are processed and print queues are managed by a print server 18 for output to a printer 20 or to a poster printer 22. Note that all of these computer functions are coordinated by a network switch 24, but could be implemented on a single computer, or any other number, or combination, of computers as required.

Additional computers (not shown) could be added to the system for additional functions. For example, a preview computer could be used to display images on preview monitors to entice contestants and other customers to the sales location. A dedicated operator computer could be provided for backroom operations. Other computer system architectures are possible, and many have been implemented in Kodak EPX installations.

The present invention is preferably implemented in relation to a typical non-competitive event situation, such as a charity walk. A charity event represents a simpler embodiment of the race scenario previously described. In this scenario, participants (instead of contestants) perform some activity such as walking, running, skating, bike riding or the like to help raise funds or attention for a charity. The start and finish line are frequently the same location, and there is usually only one photographic location for the event, usually at the finish line. Participants do not have a bib or other unique identification number, but they do have an article that identifies them uniquely through a non-contact communication method (e.g. RFID, etc.). Images are usually captured of groups of people, although images of individuals may be taken.

For such events, photographic products may be paid for in advance, in which case no preview function is necessary. However a mix of prepaid and spontaneous purchases is more likely.

At a charity event, the participant initially registers by providing personal information that is stored in a registration database. This registration is preferably done on-line, although on-site registration may also be made available. The participant is issued a participant/contestant ID number (CID) that is recorded in the registration database. The CID may also be provided on a badge, pass or other article that the participant can carry or wear. In the prior art, for example, the article could contain a radio frequency identification (RFID) tag. These articles include the CID and may also include a unique tag article ID (TID) number. Information relating the CID and the TID is recorded in the registration database or in an article database (which could be different from the registration database). Information relating the CID and the TID may also be recorded in the (RFID) tag device.

In the preferred charity event implementation, the participant is provided with an article having a CID and an RFID tag with the TID and the CID. In this implementation, the RFID tag is incorporated into the article, such as a wrist band, that is intended for wearing.

In practicing the invention, photographic stations are located at one or more points on the event route. Each photographic station includes one or more stages where participants can have their image captured. Each station includes a means to read information from the RFID tag (or other article) of the participant, and a way to associate that information with other data such as time, location, etc. An alternative embodiment has a means to read information from the RFID tag at each stage. The resulting compilation of data is generically referred to herein as event data or information. This event data or information is stored in an event time database, which may stand alone or be part of another database.

The photographic station also includes at least one camera that captures one or more images of the participants. The camera associates data such as time, image number, camera number, etc., with the image. It is important to note that the camera does not capture data about the participant, thereby meaning that the event data and the image data are captured asynchronously. The resulting compilation of data from the camera is generically referred to herein as image data or information. This image data or information is stored in a camera image database, which also may stand alone or be part of another database.

The event data or information and the image data or information from the various databases, including the event time database and the camera image database, is correlated using the CID, TID, time, location and other data. This correlation is accomplished, as will be described, according to the method of the invention, using well know database techniques to implement the method. The correlation may occur in real time, after the event is complete, or periodically as required. Consequently, the correlation may occur at a server or processor at the photographic station, or at a server or processor located elsewhere, including at a location accessible over a network, such as the Internet.

FIG. 2 shows the basic functions performed according to the present invention, including a preparation function 26, a capture function 28, a correlation function 30, a preview function 32 and a printing function 34. Each of these functions will now be discussed in greater detail.

Preparation Function

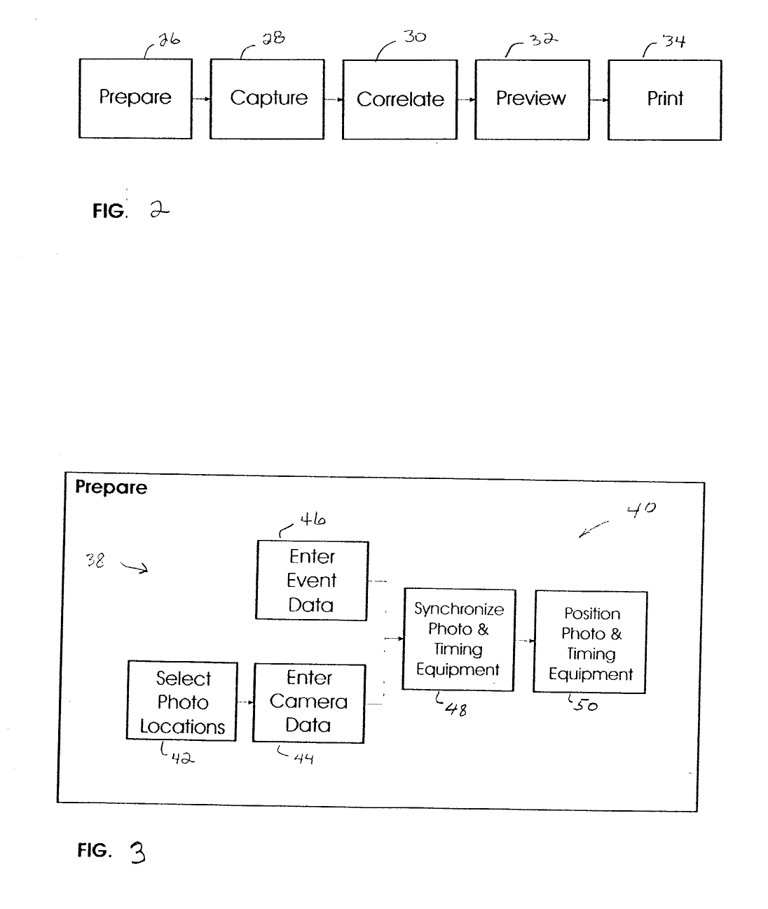

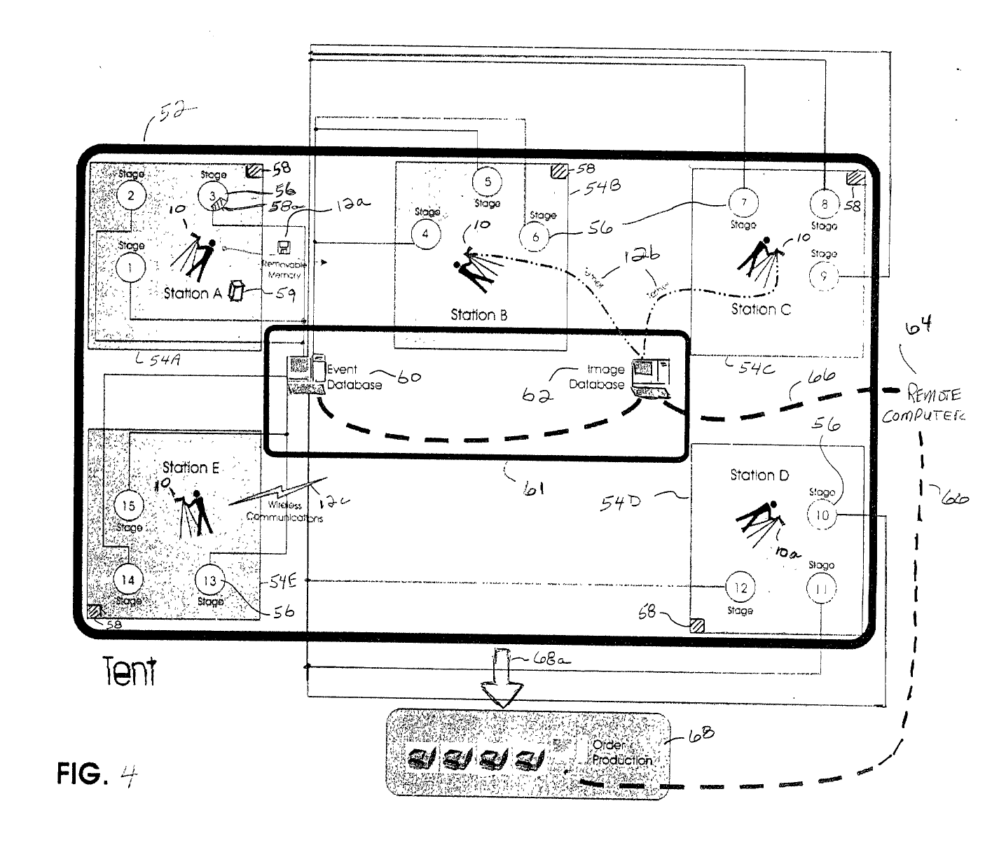

The preparation function can occur anytime prior to the start of the event. As shown in FIG. 3, there are generally two parallel activities that occur: event preparation 38 and photography preparation 40.

The event preparation 38 starts with design of the event course and selection of the event photo locations (in the photo location step 42). Appropriate preliminary camera data, such as camera number, operator, and the like, is then entered into the camera image database in a data entering step 44. Appropriate preliminary event data, such as event name, city, state, date, sponsor, photo locations, and the like, is then entered into the event time database in an event entering step 46. The RFID (timing) equipment is configured and synchronized in a synchronization step 48, and then it is placed at the selected locations in a placement step 50. Configuration and synchronization includes arranging the RFID equipment, including its hardware and software, so that it synchronizes with a source of timing and thereby can interact with the participants in an ordered way at the selected locations.

In the present embodiment, although not required, the event course starts and finishes at the same location. As shown in FIG. 4, a photographic area 52, enclosed, e.g., by a tent, is established at the start/finish location. Multiple photographic stations 54A-54E are placed in the photographic area 52. Each photographic station comprises one or more stages 56 (or platforms or sets) where the participants can be photographed. Each photographic stage (or station) has a unique RFID location tag 58 associated with it. The event data or information, including the photographic stage location tag information, is stored in an event database 60. The image data or information, including the photographic image information from the cameras 10, is stored in an image database 62. Information from the event and image databases 60 and 62 may be connected (via a server or processor, not shown) to a remote computer 64 via a network 66, such as the Internet, or by other means such as a local area network. Production of photographic orders at an order production location 68 may be performed at the same (tent) or nearby location (signified by the arrow 68a) or at another location, for example an on-line location accessible over the network 66.

Appropriate camera data is entered into the camera(s) 10 and/or other photography support components such as computers and databases, for example the image database 62. Camera data may include such information as camera ID, event description, date, location, photographic station, stage location, exposure information, photographer name, etc. The camera(s), and optionally the other photography support components, are then synchronized to the event timing equipment in the synchronization step 48. The photo equipment is then positioned at the selected locations 54A-54E in the placement step 50 and made ready to capture images.

Photographs may also be captured at locations where there is no timing equipment. While photographs are usually taken “manually” at the will of the photographer, the taking of the photographs could be “triggered” by auxiliary camera triggering equipment such as a photocell, an independent RFID detector, one or more timers, or other methods that the photographer, including in certain situations a participant/photographer, may choose to use.

Capture Function

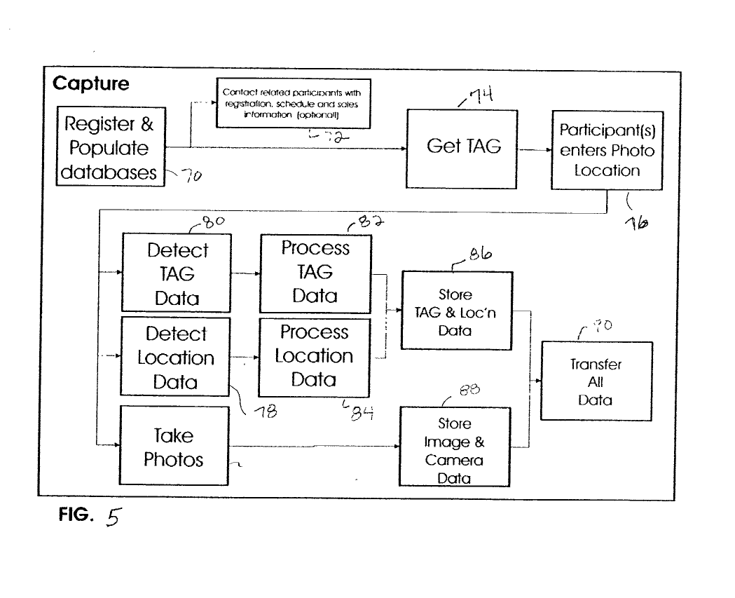

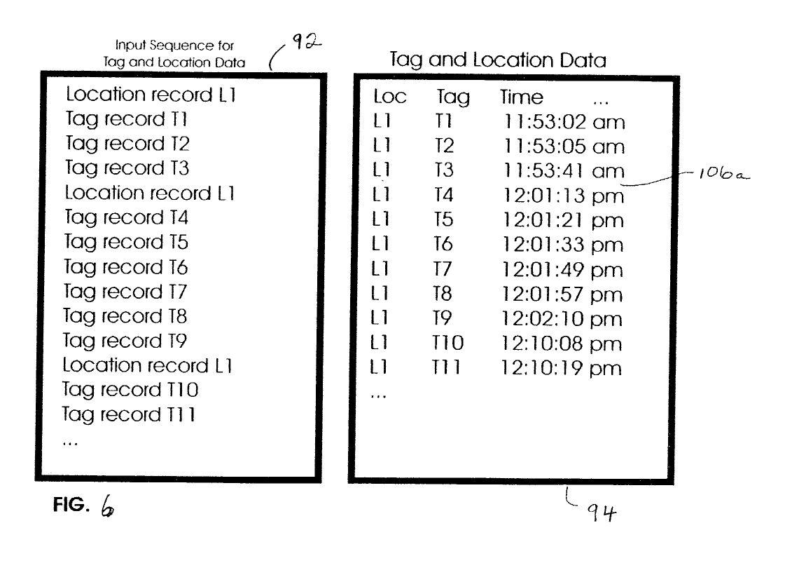

The capture function is shown schematically in FIG. 5. First the participant registers with the event in a registration step 70. This is ideally done on-line, although other methods including mail and on-site registration could be made available. Among the registration information gathered is an indication of whether the participant belongs to a group and if true, some identifying information for other members of the group may be obtained.

The participant is also given the opportunity to schedule one or more photographic sessions at the charity event. The participant may also pre-purchase any of a variety of photographic products.

In an additional function, the information about the other group members may be compared to the registration database. If the other members have not yet registered, then registration, schedule and sales information may be sent to those other members in an optional group promotional step 72. If the other members have registered but have not signed up for a photographic session, the information from the current participant may be sent to the other group members to let them know when a photo session has been scheduled, and offer them the opportunity to purchase photo products as well. Other information and sales information may be sent to other members in similar ways. The preferred communication method is email although other methods are also possible.

As each participant arrives at the event, they obtain a tag article such as a wrist band or badge at a tag providing stage 74. The tag data is entered into the event database 60, or a tag database portion of the event database, and the participant enters the photo location (entry step 76).

As shown in FIG. 4, each photographic station 54A-54E includes one or more photographic stages 56 where participants can have their picture taken. In one embodiment, a photographic area 52 such as a tent has photographic support equipment 61, including the databases 60 and 62 and ancillary processors and workstations (not shown), located in the center of the tent, and multiple photographic stations 54A-54E located around the perimeter of the tent.

Thus, in this embodiment, the tent covers several photo stations (54A-54E). Each photo station preferably includes a plurality of stages 56, e.g., three stages 56-1, 56-2 and 56-3 are shown for station 54A. A photographer at each station captures images of participants when they are assembled on a stage 56. While one stage is being photographed, participants can be assembling at a second stage and others can be leaving the third stage under the guidance of an assistant (not shown). Each stage has a location ID device (e.g. RFID chip) 58. A reader may be located at each station and/or at each stage. Data from the readers is sent to the event database 60, shown here as an independent computer. Captured images are sent to the image database 62, shown here as another independent computer, although it is possible for both databases to reside on a single computer. Images are sent to the image database 62 by direct link (a tether 12b, e.g., in Stations 54B and 54C), by removable memory 12a such as a memory card or floppy disk (e.g. in Station 54 A), by a wireless communication device 12c (e.g., in Station 54E), by a dockable camera 10a (e.g., in 54 D), or by scanned film or by any other means known to those in the art. Information from the event and image databases 60 and 62 may be communicated to the remote computer 64 via the network 66 or other means. Production of photographic orders may be performed at the same location or at a remote location 68.

The photographic stations may all be the same, or there may be a unique theme or attraction at some or all of the stations. For example, some stations could have a celebrity who poses with the participants for a picture with them. Other stations could have sets or other image compositing options such as provided by the aforementioned Kodak EPX technology.

As mentioned above, each photographic station 54A-54E may have one or more photographic stages 56. For example, referring to photographic station 54A, this configuration allows the photographer to be photographing participants on one stage 56-1 while other participants gather on another stage 56-2, and yet other participants exit a different stage 56-3. Each photographic station has a unique RFID location tag 58; additionally, or alternatively, each photographic stage 56 may also have a unique RFID stage location tag 58a (which may be similar to the RFID station location tag 58).

Either the photographer or an optional assistant directs participants to a stage. In one embodiment, referring again to FIG. 4, the photographic stage tag ID information is read at a location detection stage 78 and then the tag ID information is read by a tag detection stage 80 for each participant on the stage, using a hand held or portable RFID reader 59 located near the stage, or some similar method. Alternatively, the photographic stage tag ID information could be read after all participants tags have been read; in yet another scenario, the photographic stage tag ID could be read both before and after the participants tags have been read. In some embodiments it is possible to not read the stage tag ID when the participants tag IDs are read.

Alternative methods for reading the tag ID data could employ an antenna unit mounted on a stand, a wall, overhead, or on a floor (e.g., on a timing mat of the type conventionally used in races to detect an article with an RFID chip) to read the RFID data. In the first two alternatives, if the antenna or reader is mounted on a stand or a wall, the participants would merely wave their tag articles near the reader. Yet another alternative would have an RFID reader integrated with the camera to capture the tag ID data, as described in the aforementioned U.S. patent application Ser. No. US2002/0101519 A1. In the latter case, the RFID data may be sent directly to the camera for storage with image data, instead of being stored in a separate database.

The readings generated by the handheld or portable RFID reader 59 are then transferred to the photographic support equipment 61, and a record is then created including the tag ID, time, location and other information. More specifically, referring to FIG. 5, all tag data from participants and from station and stage location tags are processed in tag and location processing steps 82 and 84 and stored (in storage step 86) in the event database 60.

The tag ID data collected for a given stage might be stored in a number of database configurations. FIG. 6 shows how one input sequence of tag and location data might be recorded in a tag and location database. In this example, the assistant first reads the stage location RFID tag (record L1), and then reads the tag article from each participant on the stage (T1, T2, T3)—as shown in the input sequence 92 for tag and location data. A record 94 is created including location, tag ID and time. After the photo has been taken, the first group of participants leaves the stage and a second group assembles. Again the assistant reads the stage location RFID tag (record L1) and then reads the tag articles from each participant in the second group (T4, T5, . . . T9). This process repeats until all participants have been photographed. Note that the participants on stage may be comprised of participants from more than one group.

In the above example, the stage location tag ID is used as a leading separator for the participant data. As mentioned earlier, the stage location tag ID could also be used as a trailing separator of participant data. In yet another alternative, the stage location tag ID could be read both before and after reading the tag ID of all participants in the group. It is also possible to collect participant data without using a stage location tag ID, but this would require a different correlation algorithm to locate desired images.

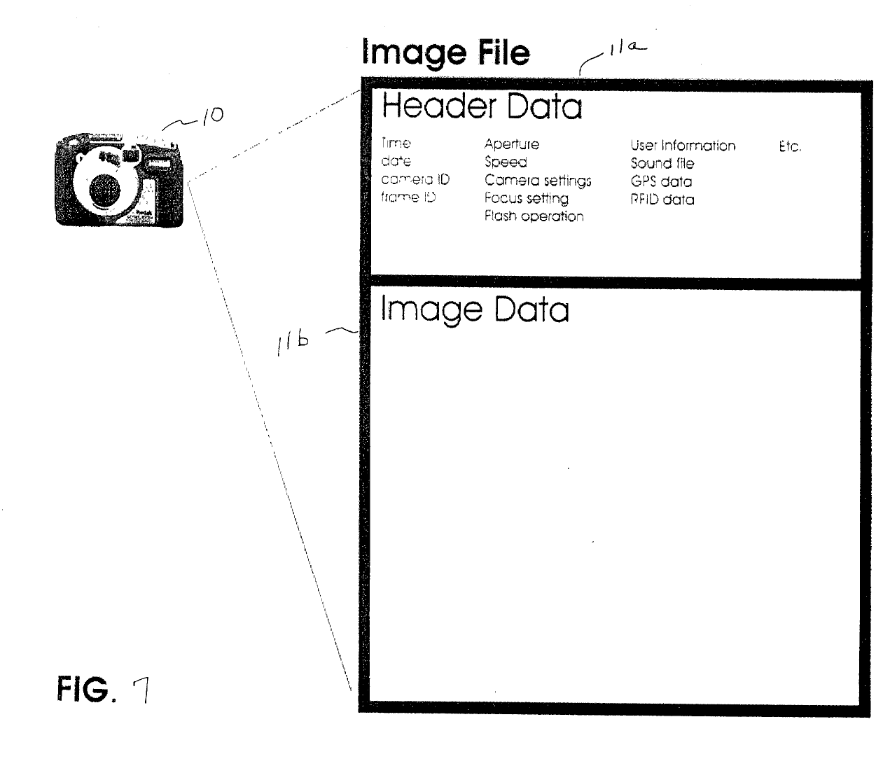

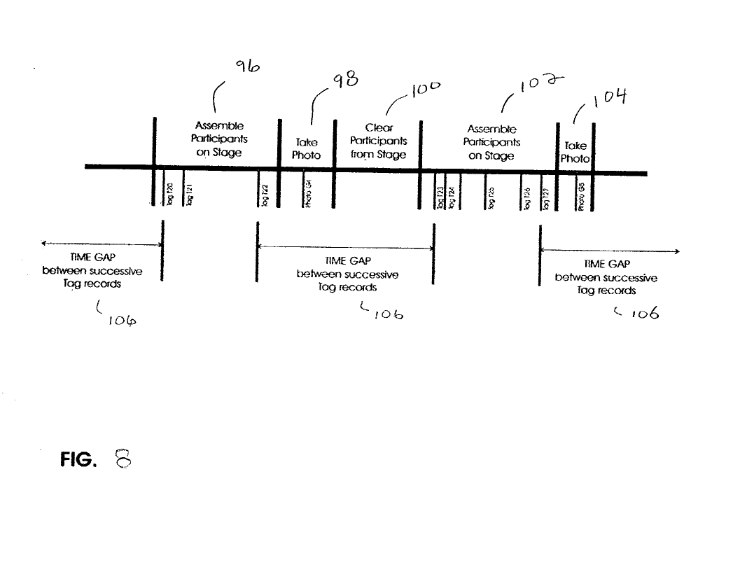

The photographer can move from stage to stage within the photographic station, capturing images when the participants are fully posed. The camera and image data are then stored (in a storage step 88) as before in the camera database 62. As shown in FIG. 7, a digital image file produced by the camera 10 typically has two portions: a header 11a and image data 11b. The header may contain without limitation a wide variety of information, such as camera data, exposure data, user data, image data, time/data of capture, global positioning (GPS) data, etc. For the particular purpose of the present invention, the header 11a contains the time and/or data of image capture, which will be used to correlate the images with the identities of the participants in the images. Camera and tag ID (event) data may then be transferred (in a transfer step 90) to another system for subsequent processing and correlation. Such other system can be the on-premise photographic support equipment 61, the remote computer 64, or any other processor capable of performing the processing and correlation.

Correlation Function

Once event data and image data are available, a correlation function 30 (see FIG. 2) is implemented to link related personal, tag, event and image data. In general, correlation is implemented by producing a separator between the event data corresponding to at least some of the events, e.g., corresponding to clusters of events that respectively relate to captured images. For instance, each event corresponds to the arrival of a person on a particular stage and the cluster delineated by the separator corresponds to all of the persons in a given image. Then the images are correlated with the event data by relating an image that is associated in time with the separator to event data that is nearby the separator. As follows, the separator is described without limitation to be either a time gap or a location record. Other types of separators may be designed by those of skill in this art, and are intended to be within the scope of this invention and the claims associated therewith.

In one embodiment, the separator is based on a time gap between successive groups of participants on a given stage 56. More specifically, FIG. 8 depicts the workflow at a given stage 56. First a group of participants assembles on a first stage (assembly step 96). The photographer takes the image (photo step 98); then, while the participants leave the first stage (clear step 100), the photographer can move to a second stage to photograph others. In the meantime, another group of participants assembles on the first stage (assembly step 102) and are photographed (step 104), and the sequence continues until all participants have been photographed.

This sequence of events results in a time gap 106 during which no tag ID records are created for a given stage (but nonetheless while the photo is being shot and the stage subsequently cleared). Importantly, the photo is shot during this time gap. This location of time gap relative to the timing of the tag ID records thus forms a linkage between the asynchronously captured event data and image data, and enables the association of the event data with selected images. Accordingly, one method for correlating image data to event data depends on locating the time gap in the event database that corresponds to the image in question, and then locating all tag IDs of the group of participants immediately prior to the time gap. For instance, referring to the record 94 shown in FIG. 6, there is a time gap 106a between the tag records for tags (i.e., participants) T1, T2, T3 and T4, T5, T6, T7, T8, T9. By identifying this gap, the images captured just before (or after) the time of the gap can be associated with the individual participants.

Alternatively, one tag ID could be located in the event database and the immediately following time gap identified. Then all images that were shot at that stage in the following time gap would be related to the group of participants.

In another embodiment, the separator is a location record of a location where an image is captured that is associated with at least some of the events and the image is correlated with the event data by relating an image that is associated in time with the location record to event data that is nearby the location record. For example, the correlation function may be based on using the location tag ID (e.g., the location record R1 in the input sequence 92 in FIG. 6) to separate groups of records for the participant (event) data. Since the stage location tag ID is used as a leading (or trailing) separator for the participant data, the image(s) captured just after (or before) the stage location tag ID can be associated with the tag records for individual participants, and therefore with the identity of the persons in the image.

It should also be understood that the separator of the previous embodiments, whether a time gap or a location record, may be associated with a single event, i.e., a single tag record for a single participant on a given stage (in other words, an image of one person). Moreover, the separator may precede or follow the pertinent records, e.g., in a situation where the image is captured prior to capturing the tag IDs of the participants, the time gap (during which the image was captured) will precede the pertinent records. In other situations, the separator may comprise both a header and a trailer, e.g., in a situation where the location RFID tag is swiped both before and after the image is captured and the two resulting location records temporally delimit both preceding and trailing boundaries of the event records.

The correlation procedure described heretofore may be seen as a technique for linking an image with one or more tag IDs of persons in the image. It is another aspect of the correlation functionality that the search can be reversed to find those images in which a particular person appears. Since each person has a tag ID record associated with a separator, and each separator is associated with an image, it becomes a straightforward application of the disclosed correlation procedure to link a tag ID of a person, or one or more persons, with those (one or more) images in which the person, or one or more persons, appears.

Previewing Function

Selected images may be displayed either by the operator or the participant in several ways, as demonstrated by existing Kodak EPX systems. For example, for direct participant viewing, preview monitors would be provided in the tent site. For combined participant and operator viewing, the POC monitor 16 (see FIG. 1) may be used by both the operator and the participant to view selected images, add optional borders, text or creatives, and select images for output. For strictly operator viewing, backroom operations may be used for marketing, censoring, pre-paid package production, database management, etc. In the case where all products are ordered prior to the event, the preview function, at least for direct participant viewing, might be eliminated.

Printing Function

Once the images are selected and edited, orders for a variety of products (prints, CDs, t-shirts, mugs, etc., as well as packages of products) can be placed at the charity event. Alternatively the images and other data could be transferred to a remote location for processing and fulfillment, i.e., images or product orders could be uploaded to the Internet for remote viewing, storage or product production. For example, the charity event might take place in one city or state and the products could be made in another city or state. Completed products could then be delivered to the participants by mail or other standard shipping method. Other types of products could also be delivered, including albums or storybooks, Picture CDs with participant images and event content combined, publicity documents and news articles, etc.

The invention has been described with reference to a preferred embodiment. However, it will be appreciated that variations and modifications can be effected by a person of ordinary skill in the art without departing from the scope of the invention.

### Parts List

10 camera(s)

10a dockable camera

11a header

11b image data

12a storage media

12b tethered link

14 download computer

16 point of consumer computer

18 print server

20 printer

22 poster printer

24 network switch

26 preparation function

28 capture function

30 correlation function

32 preview function

34 printing function

38 event preparation

40 photography preparation

42 photo location step

44 data entering step

46 event data entering step

48 synchronization step

50 placement step

52 photographic area (tent)

54A-E photographic stations

56 stages

58 RFID location tag

59 handheld or portable RFID reader

60 event database

61 photographic support equipment

62 image database

64 remote computer

66 network

68 order production location

70 registration step

72 group promotional step

74 tag providing step

76 entry step

78 location detection stage

80 tag detection stage

82 tag processing stage

84 location processing stage

86 storage stage

88 storage stage

90 transfer stage

92 input sequence

94 record

96 assembly step

98 photo step

100 clear stage step

102 assembly step

104 photo step

106 time gap

What is claimed is:

1. A method for correlating asynchronously captured event data and images associated with the events, said method comprising the steps of:
(a) capturing a plurality of images and recording data corresponding to the images, including a time of image capture for each image;
(b) recording event data associated with a plurality of events, including a time of occurrence of each event, wherein a separator is produced between the event data corresponding to at least some of the events; and
(c) correlating the images and the event data by relating an image that is associated in time with the separator to event data that is nearby the separator.

2. The method as claimed in claim 1 wherein the separator is a header that precedes the event data corresponding to at least some of the events.

3. The method as claimed in claim 1 wherein the separator is a trailer that follows the event data corresponding to at least some of the events.

4. The method as claimed in claim 1 wherein the separator comprises a header and a trailer that both precedes and follows the event data corresponding to at least some of the events.

5. The method as claimed in claim 1 wherein the separator is a time gap that is produced between the times of at least some of the events and step (c) comprises correlating an image with the event data by relating an image captured within the time gap to event data that is nearby in time.

6. The method as claimed in claim 1 wherein the separator is a location record of a location where an image is captured that is associated with at least some of the events and step (c) comprises correlating the image with the event data by relating an image that is associated in time with the location record to event data that is nearby the location record.

7. The method as claimed in claim 1 wherein the event is the placement of a person in an image and wherein step (c) further comprises correlating the images and the event data to identify one or more of the persons appearing in the images.

8. The method as claimed in claim 1 wherein the event is the placement of one or more particular persons in an image and wherein step (c) further comprises correlating the images and the event data to identify those images in which the one or more particular persons appear.

9. A method for correlating asynchronously captured event data and images associated with the events, said method comprising the steps of:
(a) capturing a plurality of images and recording data corresponding to the images, including a time of image capture for each image;
(b) recording event data associated with a plurality of events, including a time of occurrence of each event, wherein a time gap is produced between the times of at least some of the events; and
(c) correlating the images with the event data by relating images captured within the time gaps to event data that is nearby in time.

10. The method as claimed in claim 9 wherein the capture location is recorded with the data corresponding to the images.

11. The method as claimed in claim 9 wherein the event location is recorded with the event data associated with the plurality of events.

12. The method as claimed in claim 9 wherein the events include the placement of one or more persons in the captured images.

13. The method as claimed in claim 12 wherein the event data associated with the plurality of events includes identification of the persons placed in the images and the step of correlating the images with the event data includes relating the captured images with the identification of the persons in the images.

14. A method for correlating asynchronously captured event data and images associated with the events, said method comprising the steps of:
(a) capturing a plurality of images and recording data corresponding to the images, including image data and a time of image capture for each image;
(b) recording event data associated with a plurality of events, including a time and location of each event, wherein groups of the events tend to be clustered in time and delineated by a separator; and
(c) correlating the images with the event groups by using the separator to relate image data to event data that is nearby in time.

15. The method as claimed in claim 14 wherein the events include the placement of one or more persons in the captured images.

16. The method as claimed in claim 15 wherein the event data associated with the plurality of events includes identification of the persons in the images and the step of correlating the images with the event groups includes relating the captured images with the identification of the persons in the images.

17. The method as claimed as in claim 16 wherein the groups of the events comprise the respective arrival times of each person that is placed in a particular captured image.

18. The method as claimed in claim 17 wherein the data associated with the plurality of events includes identification of the persons in the images and the step of correlating the images with the event groups includes relating the particular captured image with the identification of the persons in the event group that is correlated to the image.

19. A method for correlating asynchronously captured event data and images associated with the events, said method comprising the steps of:
(a) capturing a plurality of images and recording data corresponding to the images, including a time of image capture for each image;
(b) recording event data associated with a plurality of events, including a time of occurrence of each event, wherein a location record is produced that separates the event data corresponding to at least some of the events; and
(c) correlating the image with the event data by relating an image that is associated in time with the location record to event data that is nearby the location record.

20. The method as claimed in claim 19 wherein the events include the placement of one or more persons in the captured images.

21. The method as claimed in claim 20 wherein the data associated with the plurality of events includes identification of the persons placed in the images and the step of correlating the images with the event data includes relating the captured images with the identification of the persons in the images.

22. A system for capturing images and correlating asynchronously captured event data and images associated with the events, said system comprising:
a camera system for capturing a plurality of images and recording data corresponding to the images, including a time of image capture for each image;
a data recording system for recording data associated with a plurality of events, including a time of occurrence of each event, wherein a separator is produced between the event data corresponding to at least some of the events; and
a processor for correlating the images with the event data by relating an image that is associated in time with the separator to event data that is nearby the separator.

23. The system as claimed in claim 22 wherein the events include the placement of one or more persons in the captured images.

24. The system as claimed in claim 23 wherein the data associated with the plurality of events includes identification of the persons placed in the images and the processor, which correlates the images with the event data, also relates the captured images with the identification of the persons in the images.
